(19) United States
(12) Patent Application Publication
(10) Pub. No.: US 2006/0185735 A1
(43) Pub. Date: Aug. 24, 2006

(54) Electromagnetic combination valve

(75) Inventors: Shigeto Tsuge, Okazaki-city (JP); Yasuo Kato, Niwa-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/356,182

(22) Filed: Feb. 17, 2006

(30) Foreign Application Priority Data
Feb. 18, 2005 (JP) 2005-42615

(51) Int. Cl. F16K 31/14

(52) U.S. Cl. 137/495

(57) ABSTRACT

An electromagnetic combination valve has an electromagnetic driving portion, a housing, a spring, and a first and a second valves. A coil in the electromagnetic driving portion generates a magnetomotive force when it is energized to attract the first valve to open the first valve. The second valve opens by being urged to the one side in an axial direction by the spring when a pressure of a fluid to urge the second valve in a valve-closing direction of the second valve decreases to a predetermined value when the first valve opens. The second valve has a sealing rubber on an end face thereof, to form an airtight seal at a gap between a valve seat of the housing and the second valve. The sealing rubber generates a repulsive force smaller than the urging force of the spring in the axial direction.

### CROSS REFERENCE TO RELATED APPLICATION

This application is based upon and claims the benefit of priority of Japanese Patent Application No. 2005-042615 filed on Feb. 18, 2005, the content of which is incorporated herein by reference.

### FIELD OF THE INVENTION

The present invention relates to an electromagnetic combination valve provided with a first valve acting as an electromagnetic opening/closing valve and a second valve acting as a pressure-sensing valve, which is used as an electromagnetic tank-sealing valve and the like.

### BACKGROUND OF THE INVENTION

U.S. Pat. No. 6,526,951-B2, for example, discloses an electromagnetic combination valve provided with a first valve member (hereinafter referred to as first valve) and a second valve member (hereinafter referred to as second valve). The first valve opens when a solenoid coin in an electromagnetic driving portion attracts a moving core to one side in its axial direction. The second valve lifts off a cylindrical valve seat of a housing and opens when a backpressure, which acts on the second valve in a direction to close the second valve (in a valve-closing direction of the second valve), decreases to a valve-opening pressure of the second valve and a spring force of a coil spring urges the second valve to the one side in the axial direction. In the electromagnetic combination valve, the first valve acts as an electromagnetic opening/closing valve, and the second valve acts as a pressure-sensing valve. The pressure-sensing valve means a valve device with a valve-opening property to open when the backpressure, which acts on a rear face (pressure-receiving face) of the second valve, becomes smaller than the spring force of the coil spring.

In the electromagnetic combination valve disclosed in U.S. Pat. No. 6,526,951-B2, the valve-opening pressure of the second valve is determined based on a relation between a pressure-receiving force acting on the rear face of the second valve in the valve-closing direction, which is the product of a seal diameter and the backpressure, and the spring force acting on the front face of the second valve, which is another face than the pressure-receiving face, in a valve-opening direction of the second valve. In the electromagnetic combination valve, the second valve is provided with a rubber contact member (hereinafter referred to as sealing rubber), which is to come in contact with the valve seat of the housing. Thus, when the first valve is seated on the valve seat of the second valve, that is, when both the first and the second valves are closed (in valve-closing states), the sealing rubber is elastically deformed and shrunk. Accordingly, the sealing rubber generates repulsive force in the valve-opening direction.

Accordingly, in a case that the magnetomotive force of the solenoid coil of the electromagnetic driving portion attracts the moving core to the one side in the axial direction, just after the first valve lifts off the valve seat of the second valve and opens by integrally moving with the moving core, the second valve lifts off the valve seat of the housing before the backpressure decreases to the valve-opening pressure of the second valve, due to the spring force to push up the second valve in the valve-opening direction and the repulsive force of the sealing rubber. That is, a malfunction occurs in the second valve that acts as the pressure-sensing valve.

Further, in the electromagnetic combination valve, the second valve, which is installed in the housing to be slidable in the axial direction, is not supported by an inner circumferential face of the housing. Thus, depending on a seating state of the second valve, the coil spring may be distorted on the skew, and an off-center load acts on the second valve. As a result, the second valve is pushed up in a slanting direction just after the first valve opens, to make a compression state of the sealing rubber uneven and the valve-opening pressure unstable. If the second valve is repeatedly opened and closed under this condition, the second valve may come off the valve seat of the housing together with the sealing rubber, so that an airtightness between the valve seat of the housing and the sealing rubber of the valve seat cannot be secured. This action decreases the durability and the reliability of the electromagnetic combination valve.

### SUMMARY OF THE INVENTION

The present invention, in view of the above-described issues, has an object to provide an electromagnetic combination valve that has a highly reliable second valve acting as a pressure-sensing valve, and an electromagnetic combination valve that has a stable valve-opening and valve-closing timings and prevents the second valve from coming off, by providing a housing with a valve-sliding portion to support the second valve to be slidable in its axial direction.

The electromagnetic combination valve has: an electromagnetic driving portion, a housing, a spring, a first valve and a second valve. The electromagnetic driving portion has a coil that generates a magnetomotive force when it is energized. The housing has a valve seat formed in an approximately cylindrical shape in which a fluid passage hole is formed. The spring generates an urging force in an axial direction of the housing. The first valve is installed in the housing to be slidable in the axial direction. The first valve opens by being attracted to one side in the axial direction by the magnetomotive force generated by the coil. The second valve is installed in the housing to be slidable in the axial direction. The second valve opens by being urged to the one side in the axial direction by the urging force of the spring when a pressure of a fluid to urge the second valve in a valve-closing direction of the second valve decreases to a predetermined value when the first valve opens. The second valve has a sealing rubber on an end face thereof, which faces the valve seat of the housing to seat on the valve seat of the housing in a valve-closing time of the second valve, to form an airtight seal at a gap between the valve seat of the housing and the second valve. The sealing rubber is formed from rubber elastic body that generates a repulsive force smaller than the urging force of the spring in the axial direction in the valve-closing time of the second valve.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a cross-sectional view showing a principal portion of an electromagnetic combination valve according to a first embodiment of the present invention;

FIG. 2 is a schematic view showing an entire construction of an ORVR (onboard refueling vapor recovery) system including the electromagnetic combination valve according to the first embodiment;

FIG. 3 is a top view showing an entire construction of the electromagnetic combination valve according to the first embodiment;

FIG. 4 is a cross-sectional view showing an entire construction of the electromagnetic combination valve according to the first embodiment;

FIG. 5A is a cross-sectional view showing a principal portion of a resin housing in the electromagnetic combination valve according to the first embodiment;

FIG. 5B is a cross-sectional view showing a construction adjacent to a valve seat of the resin housing in the electromagnetic combination valve according to the first embodiment;

FIG. 6 is a cross-sectional view showing an entire construction of a second valve in the electromagnetic combination valve according to the first embodiment; and

FIG. 7 is a cross-sectional view showing a principal portion of an electromagnetic combination valve as a comparative example.

### DETAILED DESCRIPTION OF PREFERRED EMBODIMENTS

In the following embodiment of the present invention, unevenness of a valve-opening time and a valve-closing time of a second valve is decreased by configuring so that the repulsive force of a sealing rubber in the valve-closing time is smaller than the spring force of a spring, to achieve the object of the present invention to improve the reliability of the second valve acting as a pressure-sensing valve. Further, a housing is provided with a valve-sliding portion that supports the second valve to be slidable in an axial direction, to achieve the object of the present invention to stabilize the valve-opening time and the valve-closing time of the second valve and to prevent the second valve from coming off.

### First Embodiment

In the present embodiment, the electromagnetic combination valve 1 is incorporated in an onboard refueling vapor recovery (ORVR) system of a vehicle such as an automobile, together with a relief valve 11. The electromagnetic combination valve 1 serves as an electromagnetic tank-sealing valve. The electromagnetic tank-sealing valve includes a normally-closed electromagnetic opening/closing valve, which opens for a predetermined period while the vehicle is traveling and at a time just before a fuel tank 12 is refueled and closes at all other times, and a pressure-operated pressure control valve (pressure-sensing valve). The ORVR system is a vaporized fuel (evaporated gas) fly-off prevention system that prevents fluid such as vaporized fuel from flying off into the atmosphere by recovering the fluid such as vaporized fuel, which is vaporized (volatilized) in the fuel tank 12 of the vehicle, through a canister 13 into an engine intake pipe 14 of an internal combustion engine (hereinafter referred to as engine) such as a gasoline engine, which has negative pressure in the engine intake pipe 14. That is, the ORVR system purges the vaporized fuel in emission gas.

In the ORVR system, a connection pipe 15 communicates the fuel tank 12 with the canister 13, and another connection pipe 16 communicates the canister 13 with the engine intake pipe 14. The fuel tank 12 is provided with a pressure sensor (in-tank pressure sensor: not shown) to detect a pressure in the fuel tank 12 (in-tank pressure). In the canister 13 is installed adsorbent such as activated carbon to adsorb the fluid such as vaporized fuel. A vent pipe 17 is connected to a vent hole of the canister 13. On the way of the vent pipe 17 are provided: a filter 18 that filtrates the gas flowing into the canister 13; and a canister control valve 19 that is a normally-opened electromagnetic opening/closing valve that closes the vent hole of the canister 13 as demanded. The filter 18 passes the gas flowing from an inlet portion (the vent hole) of the vent pipe 17 and traps foreign matters contained in the gas to prevent the foreign matters from entering into the engine intake pipe 14.

Further, in the engine intake pipe 14 is installed a throttle valve 20 that adjusts an amount of intake gas fed to an intake gas passage communicated with respective combustion chambers of the engine. On the way of the connection pipe 15 is installed a tank-sealing valve unit including the electromagnetic combination valve 1 and the relief valve 11. On the way of the connection pipe 16 is installed a purge control valve 21 that adjusts purge amount of the fluid such as vaporized fuel. The connection pipe 16 is connected with the engine intake pipe 14 at a position downstream a throttle valve 20 in the airflow direction of the intake gas (at the side of an intake port of the engine). The leakage of the fluid such as vaporized fuel is checked in accordance with the following procedure. Firstly, the canister control valve 19 closes the vent hole of the canister 13. Next, the purge control valve 21 opens to introduce the negative pressure in the engine intake pipe 14 to the connection pipes 15, 16, and then the purge control valve 21 closes to completely interrupt the fluid such as vaporized fuel. After a predetermined period of time is elapsed after the purge control valve 21 is closed, a pressure sensor detects the pressure in the fuel tank 12 to detect the pressure is increased or not, to check the leakage of the fluid such as vaporized fuel.

The relief valve 11 is a pressure adjustment valve that opens when the pressure at the side of the fuel tank 12 is large enough relative to the pressure at the side of the canister 13. The relief valve 11 is formed from: valve holes (not shown) that is provided between bypass flow passages 22, 23 to detour the first and the second valves 6, 7 of the electromagnetic combination valve 1; a valve element (not shown) that opens and closes the valve holes; a diaphragm (not shown) that drives the valve element in the valve-opening direction; a spring (not shown) that urges the valve element in the valve-closing direction; and so on. The valve holes are formed in the valve body of the relief valve 11. The valve element is slidably installed in the valve body of the relief valve 11 in an axial direction of a valve shaft. The pressure at the side of the canister 13 (standard pressure) acts onto a first pressure chamber in a casing, which is partitioned by the diaphragm. The pressure at the side of the fuel tank 12 acts onto the second pressure chamber in the casing, which is partitioned by the diaphragm.

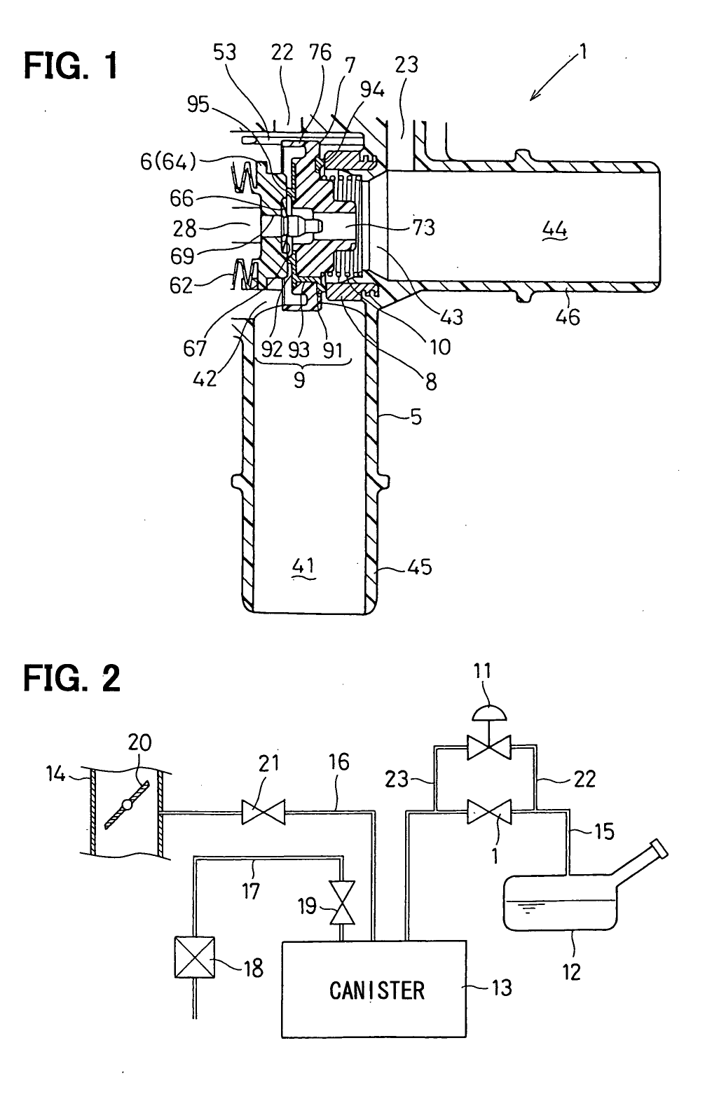

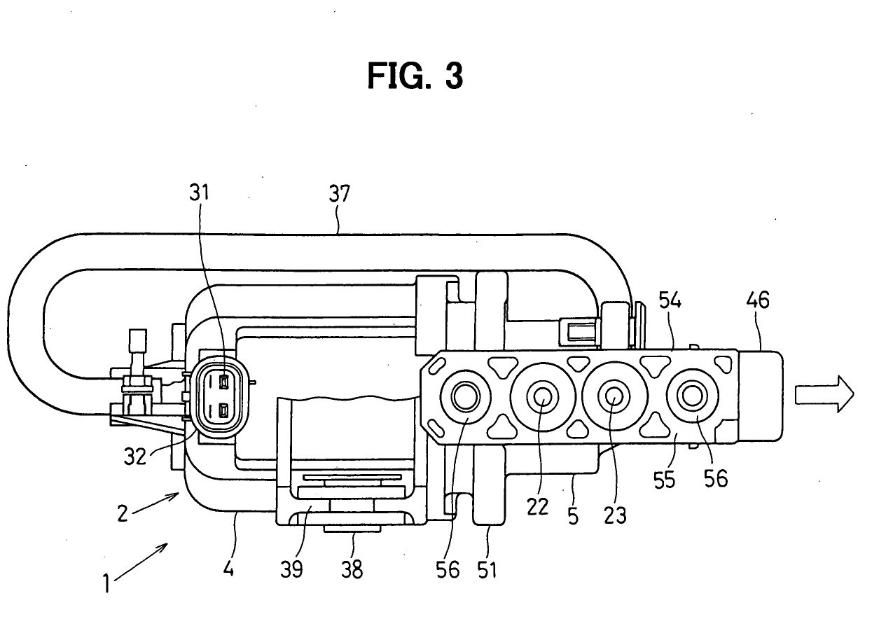

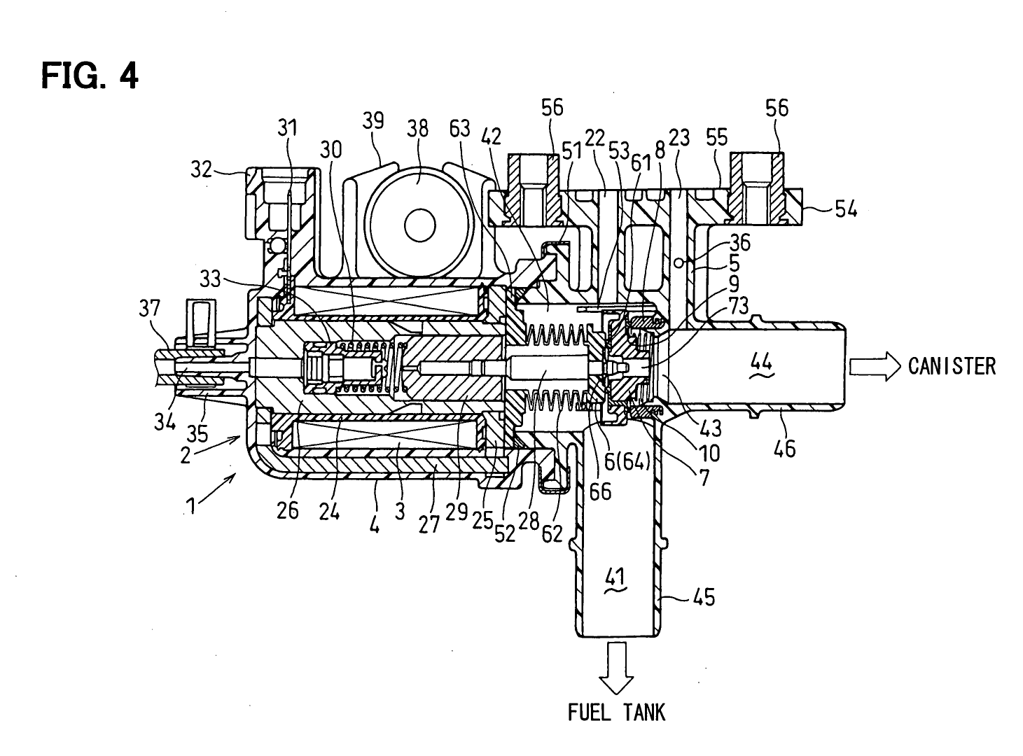

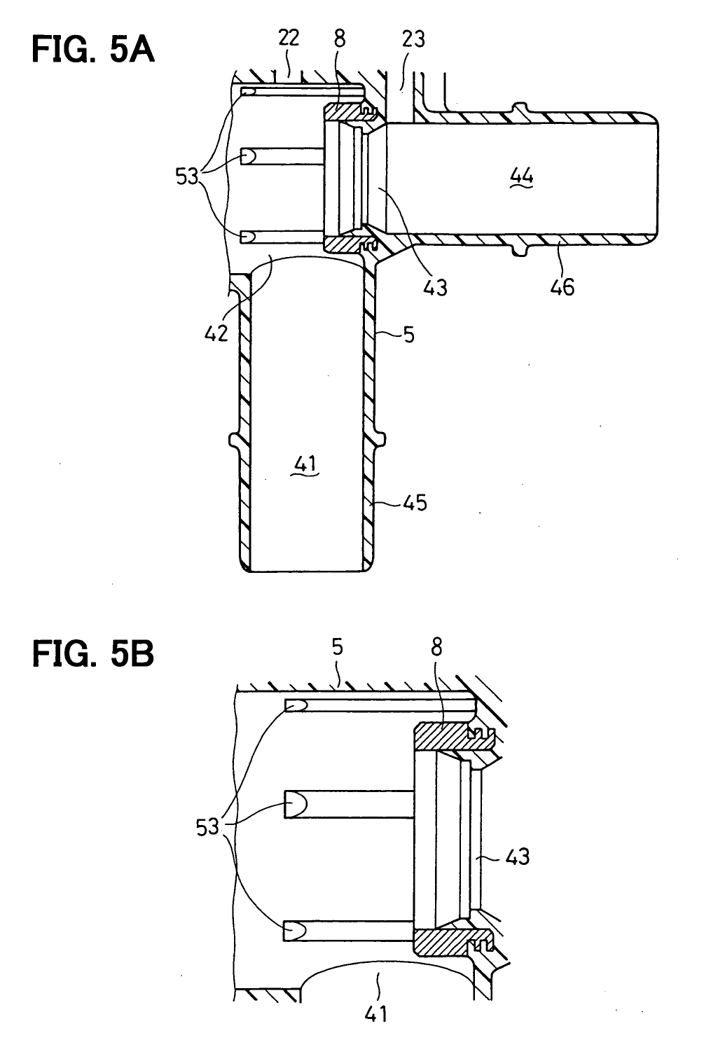

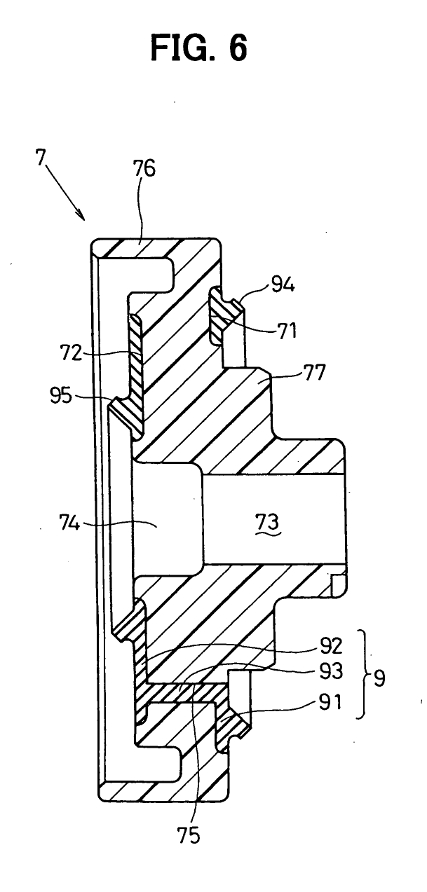

In the following is described a construction of the electromagnetic combination valve 1 according to the present embodiment, referring to FIGS. 1 to 6.

The electromagnetic combination valve 1 includes: an electromagnetic driving portion 2 that acts as an electromagnetic actuator; a resin housing 5 that is a resin molded part and swaged to be fixed to a connection end face of a resin molded member 4 of the electromagnetic driving portion 2; a first valve 6 that is a resin molded part and opens when the electromagnetic driving portion 2 drives the first valve 6 in its valve-opening direction (to one side in the axial direction); and a second valve that is a resin molded part and opens by moving in its valve-opening direction (to the one side in the axial direction) when the pressure at the side of the fuel tank 12 decreases to a predetermined value (valve-opening pressure).

The electromagnetic driving portion 2 is provided with: a solenoid coil 3 that is a wire repeatedly wound by predetermined times; a coil bobbin 24 that has a pair of flange portions between which the solenoid coil 3 is wound; a magnetic plate 25, a stator core 26 and a yoke 27 that are magnetized when the solenoid coil 3 is energized; a moving core 29 that is a magnetic body movable in its axial direction together with the first valve 6 and with the valve shaft 28 by being magnetized when the solenoid coil 3 is energized; and a return spring 30 that urges the first and the second valves 6, 7, the valve shaft 28 and the moving core 29 in the valve-closing directions.

The solenoid coil 3 is an insulated wire repeatedly wound on the coil bobbin 24, and installed in a cylindrical coil installation portion formed between the stator core 26 and the yoke 27. The solenoid coil 3 generates magnetomotive force when it is energized to magnetize magnetic members (the magnetic plate 25, the stator core 26, the yoke 27, the moving core 29, and so on), which are respectively made of magnetic material, to drive the first valve 6, the valve shaft 28 and the moving core 29 in the valve-opening direction. The solenoid coil 3 includes a coil portion that is wound on an outer circumference of the coil bobbin 24, and a pair of lead wires led out of the coil portion.

The radially circumferential portion of the solenoid coil 3 is coated and protected by a resin molded member 4, which serves as a resin case. A pair of the lead wires of the solenoid coil 3 are electrically connected by swaging, welding or the like to a pair of external connection terminals, which is to be electrically connected to an outer electric power source or to an electromagnetic valve driving circuit. The leading end portions of a pair of the outer connection terminals 31 serve as connector pins, which are exposed in a connector shell (male connector portion) 32 of the resin molded member 4 and to be plugged into a female connector portion at the side of the outer electric power source or the electromagnetic valve driving circuit to form an electric connection with the outer electric power source or the electromagnetic valve driving circuit.

The stator core 26 has an attracting portion that is magnetized to attract the moving core 29 thereto when the solenoid coil 3 is energized. In the stator core 26 is fitted a cylindrical restriction member (piece) 33 that limits longitudinal traveling distances of the first and the second valves 6, 7, the valve shaft 28 and the moving core 29. The yoke 27 forms a magnetic circuit together with the solenoid coil 3, the magnetic plate 25, the stator core 26 and the moving core 29. The moving core 29 is magnetized and attracted to the attracting portion of the stator core 26 when the solenoid coil 3 is energized. In the moving core 29 is fitted one axial end portion of the valve shaft 28. One end of the return spring 30 is supported by the piece 33, and the other end of the return spring 30 is supported by the moving core 29.

The resin molded member 4 is a secondary resin molded part that is secondary molded and made of an electrical insulating resin such as thermoplastic resin (polybutylene telephthalate: PBT, polyphenylene sulfide: PPS or polyamide resin: PA, for example). The resin molded member 4 is disposed radially outside the coil portion of the solenoid coil 3 and the coil bobbin 24. Inside the resin molded member 4 is formed the yoke 27 by insert molding, and on an inner circumference of the resin molded member 4 is fixed the magnetic plate 25. The other axial end portion (right end portion in the drawing) of the resin molded member 4 is provided with an annular connection end face, which is connected with the connection end face of the resin housing 5. The resin molded member 4 is provided with a pipe-shaped portion 35 that has a pressure release hole 34 to smooth the opening/closing motions (reciprocating motions in the axial direction) of a bellows of the first valve 6, which is described later, the valve shaft 28 and the moving core 29.

The pressure release hole 34 is communicated with a cylindrical space in the bellows of the first valve 6 via a small diameter hole formed in the stator core 26 in the axial direction, a longitudinal hole formed in the piece 33, a large diameter bore formed in the stator core 26, and a longitudinal hole formed in the moving core 29 or a clearance formed between an inner circumferential face of the stator core 26 and an outer circumferential face of the moving core 29. To the pipe-shaped portion 35 is connected a hose 37 to communicate a pressure release hole 34, which opens at one axial end portion of the electromagnetic driving portion 2, with a pressure release hole 36, which opens on the way of the bypass flow passage 23. Further, on the outer circumferential portion of the resin molded member 4 is integrally formed an attachment stay portion 39, which is screw-fastened to a ceiling wall of the fuel tank 12 with a fastening member such as a fastening bolt inserted in a through hole of a cylindrical collar 38.

The resin housing 5 is formed in a predetermined shape from a thermoplastic resin (polyphenylene sulfide: PPS, polybutylene telephthalate: PBT or polyamide resin: PA, for example). The resin housing 5 defines a valve chamber 42 between itself and the other axial end face of the electromagnetic driving portion 2 (between one end face of the magnetic plate 25 and one end face of the stator core 26), and serves as a passage member to provide two fluid passages 41, 44, which are connected to the valve chamber 42 in an approximately L-shaped fashion. In the present embodiment, the valve chamber 42 and the fluid passage 44 are communicated with each other by a fluid passage hole (valve hole) 43, which flows the fluid such as vaporized fuel therethrough.

Further, at the upstream side of the resin housing 5 (at a lower end portion in the drawing) is integrally formed an approximately round pipe-shaped fluid flow passage pipe (inlet pipe) 45, which is connected to the fuel tank 12 via an upstream end portion of the connection pipe 15. Inside the fluid flow passage pipe 45 is formed the fluid passage (tank-side fluid passage) 41. At the downstream side of the resin housing 5 is integrally formed an approximately round pipe-shaped fluid flow passage pipe (outlet pipe) 46, which is connected to the canister 13 via a downstream portion of the connection pipe 15. Inside the fluid flow passage pipe 46 is formed the fluid passage (canister-side fluid passage) 44 including the outlet port.

The valve chamber 42 is formed in an approximately cylindrical shape inside a depressed portion, which is opened toward the electromagnetic driving portion 2, of the resin housing 5 that is fitted to an inner circumference of the resin molded member 4. The valve chamber 42 forms a fluid passage in which the first and the second valves 6, 7 can reciprocatingly move in the axial direction. The fluid flow passage pipe 46 is formed in the axial direction of the resin housing 5. The fluid flow passage pipe 45 is integrally formed on an outer circumferential portion of the resin housing 5 to protrude radially outward therefrom in a radial direction approximately perpendicular to the axial direction of the resin housing 5.

In the present embodiment, an inner circumferential portion of a cylindrical portion of the resin housing 5 is provided with a cylindrical valve seat to seat the second valve 7 thereon. The valve seat of the resin housing 5 has a valve seat portion 8 on which the second valve 7 seats. The valve seat portion 8 is formed from metallic material (metal base material such as stainless steel). The valve seat portion 8 is insert molded to extend from an end face of a ring-shaped partition wall, which partitions the valve chamber 42 and the fluid passage 44 from each other, toward the electromagnetic driving portion 2. In the valve seat portion 8 is formed the valve hole 43, which communicates the valve chamber 42 with the fluid passage 44 and is opened and closed by the second valve 7.

Further, a metal ring 51 is fixed on the outer circumferential portion of the cylindrical portion of the resin housing 5 at the electromagnetic driving portion 2 side with respect to the valve seat. The metal ring 51 is for swaging the connection end face of the cylindrical portion of the resin housing 5, which is at the electromagnetic driving portion 2 with respect to the valve seat, on the connection end face of the resin molded member 4. A leading end face (tapered face) of the cylindrical portion of the resin housing 5, which is at the side of the electromagnetic driving portion 2 with respect to the valve seat, is provided with an O-ring (ring-shaped elastic body) 52 in an intimate contact state to prevent the fluid such as vaporized fuel from leaking out of the electromagnetic combination valve 1. Thus, the electromagnetic driving portion 2 and the resin housing 5 is connected with each other in an airtight state.

An inner circumferential face of the cylindrical portion of the resin housing 5, which is at the side of the electromagnetic driving portion 2 with respect to the valve seat, (an inner face of the valve chamber 42 at the side of the valve seat) is provided with a valve-sliding portion that slidably supports an outer diametrical face of a radially outermost face (outer circumferential face) of the second valve 7. The valve-sliding portion is formed from a plurality of valve guides (protruding rib portions) 53. The number of the valve guides is six in the present embodiment. These valve guides 53 protrude from the inner circumferential face of the cylindrical portion of the resin housing 5, which is at the side of the electromagnetic driving portion 2 with respect to the valve seat, toward a central axis by a predetermined protruding length. Two adjacent valve guides 53 form a fluid passage therebetween.

An upper side portion (in the drawing) of the resin housing 5 with respect to the valve seat is integrally formed a bracket 54 for fixing the valve body of the relief valve 11. In the bracket 54 is formed the bypass flow passage 22, which communicates the valve chamber 42 with a valve hole of the relief valve 11 and the second pressure chamber, and the bypass flow passage 23, which communicates the fluid passage 44 with the valve hole of the relief valve 11 and the first pressure chamber. In a fixing seat portion 55 of the bracket 54, which is for fixing the relief valve 11 thereon, is insert molded an insert nut 56, which is screw-fastened with a fastening bolt to screw-fasten the valve body of the relief valve 11.

The first valve 6 is a resin molded part that is formed from resinous material (resin base material) such as thermoplastic resin (fluorocarbon resin, polytetrafluoroethylene: PTFE, and the like). The first valve 6 is coupled to and driven by the moving core 29 of the electromagnetic driving portion 2 via the valve shaft 28. The first valve 6 is provided to be able to reciprocate in the approximately cylindrical valve chamber 42, which is formed between the electromagnetic driving portion 2 and the resin housing 5, in the axial direction. A magnetomotive force of the solenoid coil 3 moves the first valve 6 to the one side in the axial direction to open the solenoid coil 3 (valve-opening state). In a valve-opening time of the first valve 6, the first valve 6 is lifted off the molded rubber of the second valve 7, which is described later, to open a communication path, which is also described later. When the solenoid coil 3 is demagnetized to extinguish the magnetomotive force thereof, the spring force of the return spring 30 moves the first valve 6 to the other side in the axial direction to close the first valve 6 (valve-closing state). In a valve-closing time of the first valve 6, the first valve 6 is seated on the molded rubber of the second valve 7 to close the communication path.

A left end face (in the drawing) of the first valve 6 is provided with an annular plate-shaped resin seal portion (resin formed portion) 61, which can seat on the molded rubber of the second valve 7. The first valve 6 is integrally formed with a bellows 62, which is accordion-folded to be able to extend and shrink in the axial direction. At one axial end portion of the bellows 62 is integrally formed a ring-shaped flange portion 63, which serves as a fixed portion (fixing seat portion) of the first valve 6. The flange portion 63 is sandwiched between an end face of the magnetic plate 25 of the electromagnetic driving portion 2 and one end face (tapered face) of the resin housing 5 via the O-ring 52. At the other axial end portion of the bellows 62 is integrally formed a ring-shaped portion (valve body) 64, which serves as a main component (moving portion) of the first valve 6.

The first valve 6 is integrally formed in the other axial end portion of the bellows 62, and sandwiched between an annular end face of the large diameter portion of the valve shaft 28 and a wave washer 66, which is engaged with a flange portion of the valve shaft 28. As the wave washer 66, a snap washer (or a ring-shaped elastic body such as a ring-shaped leaf spring) can also be used that has a spring function to push the valve body 64, which serves as a main component of the first valve 6, onto the annular end face of the large diameter portion of the valve shaft 28. A part of the first valve 6, which is to be in contact with the wave washer 66, is a depressed portion 67 that is ring-shaped and slightly depressed with respect to the resin seal portion 61. Further, in the first valve 6 is formed a longitudinal hole 69 that communicates the annular end face at the left portion (in the drawing) of the valve body 64 with a bottom face of the depressed portion 67. The longitudinal hole 69 is a round hole coaxially disposed with the first valve 6. A right end portion (in the drawing) (the other axial end portion) of the valve shaft 28 is press-fitted in the longitudinal hole 69. Thus, the first valve 6 can integrally move with the valve shaft 28 and with the moving core 29. The right axial end portion (in the drawing) of valve shaft 28, that is, a portion protruding rightward (in the drawing) beyond the annular end face of the large diameter portion of the valve shaft 28 is a small diameter portion, which has a diameter smaller than that of the large diameter portion of the valve shaft 28.

The second valve 7 is a resin molded part that is integrally formed from resinous material (resin base material) such as thermoplastic resin (polyphenylene sulfide: PPS and the like, for example). The second valve 7 can reciprocate in the valve chamber 42 in the axial direction, as the first valve 6 does. When the first valve 6 opens and the pressure at the side of the fuel tank 12 (the pressure in the fluid passage 41 and in the valve chamber 42) decreases to a predetermined value, the spring force of the coil spring 10 moves the second valve 7 to the one side in the axial direction to open the second valve 7 (valve-opening state). In the valve-opening time of the second valve 7, the second valve 7 is lifted off the valve seat of the resin housing 5, to open the valve hole 43. In the valve-closing time of the first valve 6, the spring force of the return spring 30 moves the second valve 7 together with the first valve 6 to the other side in the axial direction to close the second valve 7 (valve-closing state). In the valve-closing time of the second valve 7, the second valve 7 is seated on the valve seat of the resin housing 5, to close the valve hole 43.

A right portion of the second valve 7 (in the drawing) is shaped in a stepped manner (in a multiply stepped-ring shape). On the annular end face of the second valve 7 (right end face in the drawing), which faces the valve seat of the resin housing 5 to form a predetermined gap therebetween in the valve-opening time of the second valve 7, is formed an annular shaped circumferential groove 71. A left portion (in the drawing) of the second valve 7 is formed in a single ring shape. On the annular end face of the second valve 7 (left end in the drawing), which faces the resin seal portion 61 of the first valve 6 to form a predetermined gap therebetween, is formed an annular shaped circumferential groove 72.

In a radially central portion of the second valve 7 is formed a communication passage 73, which communicates the left annular end face (in the drawing) of second valve 7 with the right annular end face (in the drawing) of the second valve 7. The communication passage 73 is a round hole coaxially formed to the second valve 7. When the first valve 6 is opened before the second valve 7 is lifted off the valve seat of the resin housing 5, the communication passage 73 communicates a valve chamber 42, which is located at an upstream side in a fluid flow direction with respect to the valve seat of the resin housing 5, with a fluid passage 44, which is located at a downstream side in the fluid flow direction with respect to the valve seat of the resin housing 5.

In the present embodiment, an upstream end of the communication passage 73 opens on a bottom face of the depressed portion 74, which has a bore diameter larger than that of the communication passage 73. The depressed portion 74 can prevent an interference with an axial leading end portion (the other end portion) of the valve shaft 28. In the second valve 7 is further formed a through hole 75 that communicates a bottom face of the circumferential groove 71 with a bottom face of the circumferential groove 72. The through hole 75 penetrates the second valve 7 in the axial direction (in a thickness direction of the second valve 7) at a radially off-centered position to be apart from the communication passage 73 of the second valve 7. On the outer circumferential portion of the second valve 7 is integrally formed a fitting portion (cylindrical rib portion) 76, which is slidably fitted to a plurality of the valve guides 53 of the resin housing 5. The fitting portion 76 is shaped in an approximately cylindrical shape to protrude radially outward from the outer circumferential face of the second valve 7.

In the present embodiment, the fitting portion 76 is formed from a ring-shaped flange portion, which protrudes radially outward from the outer circumferential face of the second valve 7, a cylindrical radially outermost portion (cylindrical portion, sliding portion), which extends from the outer peripheral portion of the flange portion toward the electromagnetic driving portion 2 in the axial direction, and so on. The fitting portion 76 is fitted to and supported by the inner circumferential face (inner diametrical face) of a plurality of the valve guides 53 to provide a sliding clearance with a predetermined width (around 0.3 μm to 0.7 μm, desirably around 0.5 μm, for example), to be slidable relative to the cylindrical portion at the electromagnetic driving portion 2 side with respect to the valve seat of the resin housing 5. Thus, the outer diametrical face of the radially outermost portion of the fitting portion 76 of the second valve 7 is slidably supported by the valve-sliding portion of the cylindrical portion, which is at the side of the electromagnetic driving portion 2 with respect to the valve seat of the resin housing 5, especially by the inner diametrical face of a plurality of the valve guides 53.

Then, in the present embodiment, the molded rubber (sealing rubber, rubber formed portion) 9 is mold formed on and in the annular end faces of the second valve 7. The molded rubber 9 is for improving an airtight seal performance between the second valve 7 and the valve seat of the resin housing 5 (second valve seat) and for improving an airtight seal performance between the first valve 6 and the valve seat of the second valve 7 (first valve seat). The molded rubber 9 is formed from rubber elastic body (rubber material, rubber base material: fluorine rubber, silicon rubber, and the like) that has excellent performance in durability and formability, and a softly deformable elastic performance (fine flexibility and rich elastic deformability).

In the present embodiment, the molded rubber 9 is formed from rubber elastic body that generates repulsive force to urge the second valve 7 in the valve-opening direction when the second valve 7 is seated on the valve seat of the resin housing 5. The molded rubber 9 has: a rubber seal portion 91 that is formed in a ring shape and mold formed in the circumferential groove 71, which is formed on the right annular end face (in the drawing) of the second valve 7 opposite from the pressure-receiving face; a rubber seat portion 92 that is formed in a ring shape and mold formed in a circumferential groove 72, which is formed on the left end face (in the drawing) of the second valve 7 (pressure-receiving face); a rubber filled portion 93 that is filled in the through hole 75, which is formed in the second valve 7; and so on. The second valve 7 is injection molded and cooled down, and then the second valve 7 is put in an injection molding form and the molded rubber 9 is rubber molded (mold formed) on the annular end faces on both sides of the resinified second valve 7 and in the second valve 7 by using the second valve 7 as a part of the injection molding form. The rubber seal portion 91, the rubber seat portion 92 and the rubber filled portion 93 are supported and welded on each other in this manner. The rubber filled portion 93 serves as a rubber connection portion that connects the rubber seal portion 91 with the rubber seat portion 92.

The rubber seal portion 91 is an elastic seal portion that is seated on and lifted off the valve seat portion 8 of the resin housing 5 to close and open the valve hole 43. In the present embodiment, a surface of a ring-shaped portion (base portion) of the rubber seal portion 91, which is filled in (supported by, welded on) the circumferential groove 71, is flat with respect to the right annular end face (in the drawing) of the second valve 7. Alternatively, the surface of the ring-shaped portion (base portion) of the rubber seal portion 91 may be protruded beyond or depressed from the right annular end face (in the drawing) of the second valve 7.

On the surface of the rubber seal portion 91 is formed an approximately ring-shaped sealing lip portion 94 to improve airtightness (degree of intimate contact) between itself and the valve seat portion 8 of the resin housing 5. The sealing lip portion 94 protrudes from the surface of the rubber seal portion 91 toward the valve seat of the resin housing 5 by a predetermined protruding height (around 1 mm, for example). The sealing lip portion 94 has an elastically deformable property to be flexibly and elastically deformable in any direction. Thus, the sealing lip portion 94 can securely seal the gap between the rubber seal portion 91 and the valve seat portion 8 even if there are small asperities on the surface of the valve seat portion 8 of the resin housing 5.

The sealing lip portion 94 has an approximately right angled triangular cross-section. That is, the sealing lip portion 94 has a protruding portion at its leading end portion in a seal direction (in the axial direction) in which the second valve 7 seats on the surface of the valve seat portion 8 of the resin housing 5. The surface of the leading end portion of the sealing lip portion 94 is inclined radially outward to the seal direction (to the axial direction) by the predetermined angle (around 45 degrees, for example). Thus, the sealing lip portion 94 of the rubber seal portion 91 of the molded rubber 9 is shaped to realize elastically deforming seal in any direction. Accordingly, it becomes possible to reduce repulsive force of the rubber seal portion 91 of the molded rubber 9 in the valve-closing time of the second valve 7. Consequently, the repulsive force of the sealing lip portion 94 in the valve-closing time of the second valve 7 is set to be smaller than the spring force of the coil spring 10.

The rubber seat portion 92 is an elastic seat portion on which the resin seal portion 61 of the first valve 6 is seated and off which the resin seal portion 61 of the first valve 6 is lifted, to close and open the communication passage 73. In the present embodiment, the rubber seat portion 92 is positioned so that the left annular end face (in the drawing) of the second valve 7 is flat relative to the surface of the ring-shaped portion (base portion) of the rubber seat portion 92, which is filled in (supported by or welded on) the circumferential groove 72. Alternatively, the surface of the ring-shaped portion (base portion) of the rubber seat portion 92 may be protruded or depressed from the left annular end face (in the drawing) of the second valve 7.

On the surface of the rubber seat portion 92 is provided an approximately ring-shaped sealing lip portion 95 to improve airtightness (degree of intimate contact) between itself and the resin seal portion 61 of the first valve 6. The sealing lip portion 95 protrudes from the surface of the rubber seat portion 92 toward the resin seal portion 61 of the first valve 6 by a predetermined protruding height (around 1 mm, for example). The sealing lip portion 95 has an elastic property to be flexibly deformable in any direction. Thus, the sealing lip portion 95 can securely seal the gap between the rubber seat portion 92 and the sealing lip portion 95 even when there are small asperities on the surface of the resin seal portion 61 of the first valve 6.

The sealing lip portion 95 has an approximately right angled triangular cross-section. That is, the sealing lip portion 95 has a protruding portion at its leading end portion in a seal direction (in the axial direction) in which the resin seal portion 61 of the first valve 6 seats on the surface of the rubber seat portion 92 of the molded rubber 9. The surface of the leading end portion of the sealing lip portion 95 is inclined radially outward to the seal direction (to the axial direction) by the predetermined angle (around 45 degrees, for example). Thus, the sealing lip portion 95 of the rubber seat portion 92 of the molded rubber 9 is shaped to realize elastically deforming seal in any direction. Accordingly, the sealing lip portion 95 of the rubber seat portion 92 of the molded rubber 9 has a shape, which can realize elastically deforming seal in any direction.

The coil spring 10 is a valve urging means that generates urging force (spring force, spring load) to urge the second valve 7 in the valve-opening direction, that is, toward one side (the first valve 6 side) in the axial direction. One end of the coil spring 10 is supported by a portion of the molded rubber 9 at the proximity to the rubber seal portion 91, that is, by the valve-side hook of the second valve 7. The other end of the coil spring 10 in the axial direction is supported by a portion of the resin housing 5 at the proximity to the valve seat (the valve seat portion 8), that is, by a housing-side hook that is provided on the inner circumferential portion of wall portion (valve seat) of the resin housing 5. One axial end portion of the coil spring 10 is fitted to an outer circumference of a cylindrical spring inner circumference guide portion 77 that protrudes from the right annular end face (in the drawing) of the second valve 7 in the axial direction.

In the following are described actions and effects of the electromagnetic combination valve 1 according to the present embodiment of the present invention, referring to FIGS. 1 to 6.

When the solenoid coil 3 of the electromagnetic driving portion 2 of the electromagnetic combination valve 1 is energized, the solenoid coil 3 generates magnetomotive force, to magnetize the magnetic plate 25, the stator core 26, the yoke 27 and the moving core 29. Thus, the moving core 29 is attracted to the attracting portion of the stator core 26, so that the first valve 6, which is fixed via the valve shaft 28 to the moving core 29, moves to the one side (left side in the drawing) in the axial direction to reduce a length of the bellows 62, against the spring force of the return spring 30. When the bellows 62 of the first valve 6 is shrunk, the gas in the cylindrical space inside the bellows 62 of the first valve 6 is led through the holes of the electromagnetic driving portion 2, the pressure release hole 34 and the hose 37 to the bypass flow passage 23 (or to the fluid passage 44), so that the first valve 6 smoothly moves in the valve-opening direction.

Accordingly, the resin seal portion 61 of the first valve 6 is lifted off the rubber seat portion 92 of the molded rubber 9, which is mold formed on the second valve 7, to open the communication passage 73, which is formed in the second valve 7. Then, the communication passage 73 of the second valve 7 communicates the fluid passage 41 and the valve chamber 42, which are at upstream side (at the side of the fuel tank 12) with respect to the valve seat of the resin housing 5 in the flow direction of the fluid such as vaporized fuel, with the valve hole 43 and the fluid passage 44, which are at downstream side (at the side of the canister 13) with respect to the valve seat of the resin housing 5 in the flow direction of the fluid such as vaporized fuel. Thus, the pressure at the side of the fuel tank 12 (the pressure in the fluid passage 41 and in the valve chamber 42) gradually decreases to become equal to the pressure at the side of the canister 13 (the pressure in the valve hole 43 and in the fluid passage 44).

In this regard, the valve-opening pressure of the second valve 7 is set based on a relation between a pressure receiving force (the product of seal diameter and pressure acting in the valve-closing direction) that acts on the left annular end face (pressure-receiving face) of the second valve 7, and the spring force of the coil spring 10. Thus, when the pressure at the side of the fuel tank 12, or the pressure in the fluid passage 41 and in the valve chamber 42 decreases to the valve-opening pressure, the spring force of the coil spring 10 moves the second valve 7 to the one side (left side in the drawing) in the axial direction and opens. Accordingly, the rubber seal portion 91 of the molded rubber 9, which is mold formed on the second valve 7, is lifted off the valve seat portion 8 of the resin housing 5, so that the valve hole 43, which is formed on the valve seat of the resin housing 5 completely opens. Then, the fluid such as vaporized fuel, which is vaporized (volatilized) in the fuel tank 12, flows through an upstream side portion of the connection pipe 15 into the electromagnetic combination valve 1. The fluid such as vaporized fuel further flows from the inlet port via the fluid passage 41, the valve chamber 42, the valve hole 43, the fluid passage 44 and the outlet port into a downstream portion of the connection pipe 15, and is adsorbed by an adsorbent body in the canister 13.

Thus, when the pressure at the side of the fuel tank 12 exceeds a predetermined value (the pressure at the side of the canister 13), a diaphragm of the relief valve 11 is displaced against the spring force of the spring to move a valve shaft connecting the diaphragm with the valve element in the axial direction, so that the valve element is lifted off the valve seat to open the valve hole. When the pressure at the side of the fuel tank 12 is the predetermined value (the pressure at the side of the canister 13) or smaller, the spring force of the spring displaces the diaphragm, so that the valve shaft moves in the axial direction, so that the valve element is seated on the valve seat to close the valve hole. Thus, even when the pressure in the fuel tank 12 increases by vaporized liquid fuel in the fuel tank 12 while the first and second valves 6, 7 of the electromagnetic combination valve 1 close the valve hole 43, the fluid such as vaporized fuel, which is flown into the electromagnetic combination valve 1, further flows from the inlet port via the fluid passage 41, the valve chamber 42, the bypass flow passage 22, the valve hole of the relief valve 11, the bypass flow passage 23, the fluid passage 44 and the outlet port to the canister 13. Accordingly, it is possible to prevent the fluid such as vaporized fuel from leaking at pipe connection portions when the pressure in the fuel tank 12 increases.

As described above, in the electromagnetic combination valve 1 according to the first embodiment of the present invention, the first valve 6 acts as (the valve element of) the electromagnetic opening/closing valve, and the second valve 7 acts as (the valve element of) the pressure-sensing valve. In the valve-closing time of the first and the second valves 6, 7, the resin seal portion 61, which is provided on the right end face of the first valve 6, seats on the rubber seat portion 92, which is provided on the annular end face (pressure-receiving face) at the left side of the second valve 7, and the rubber seal portion 91, which is provided on the annular end face (opposite side face from the pressure receiving face), seats on the valve seat (the valve seat portion 8) of the resin housing 5.

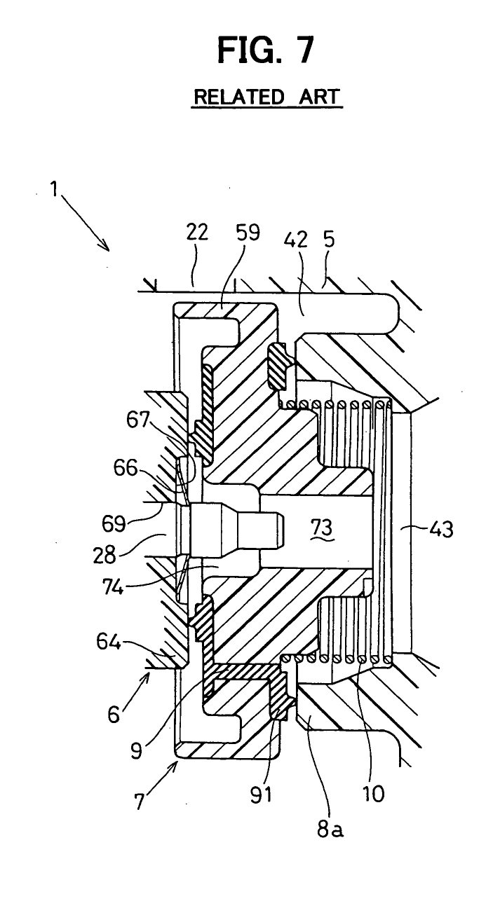

FIG. 7 depicts a comparative example of the first embodiment of the present invention. In the comparative example, the molded rubber 9 is rubber molded (mold formed) on and in the annular end faces of the second valve 7, to improve the airtightness between the first valve 6 and the second valve 7 as in the first embodiment, and further to improve an airtightness between the second valve 7 and a valve seat 8a of the resin housing 5. Thus, in the valve-closing states of the first and the second valves 6, 7, the molded rubber 9 is shrunk in the axial direction, to generate repulsive force in the molded rubber 9 in the valve-opening direction. Accordingly, the spring force of the coil spring 10 and the repulsive force of the rubber seal portion 91 of the molded rubber 9 lifts the second valve 7 upward just after a valve-opening of the first valve 6 before the pressure in the valve chamber 42 decreases to the predetermined valve-opening pressure. As a result, the comparative example has an issue that the second valve 7 does not open at the predetermined valve-opening pressure.

In the electromagnetic combination valve 1 according to the first embodiment of the present invention, the molded rubber 9, which forms the sealing lip portion 94, acts not as a compression seal but as an elastic deformation seal. Specifically, the sealing lip portion 94 is provided on the surface of the rubber seal portion 91 of the molded rubber 9, so that the second valve 7 has a lip valve construction, and the sealing lip portion 94 has an approximately right angled triangular cross-section with the surface inclined by the predetermined angle (around 45 degrees, for example) from the seal direction. Accordingly, the repulsive force of the molded rubber 9 in the valve-closing time of the second valve 7 is set to be smaller than the spring force of the coil spring 10. As a result, the second valve 7 does not lift off the valve seat (the valve seat portion 8) of the housing 5 just after the valve-opening of the first valve 6. Then, the sealing lip portion 94 of the molded rubber 9 is kept in intimate contact with the valve seat (the valve seat portion 8) of the resin housing 5 until the pressure in the valve chamber 42 decreases to the valve-opening pressure.

Accordingly, in the valve-closing time of the second valve 7, the repulsive force of the sealing lip portion 94 of the molded rubber 9 is decreased. Thus, it is possible to prevent the second valve 7 from being lifted off the valve seat (the valve seat portion 8) of the resin housing 5 before the pressure in the valve chamber 42 just after the valve-opening of the first valve 6 decreases to the valve-opening pressure, which is adjusted to the pressure in the valve chamber 42. Then, it is possible to decrease a variation of a valve-opening time of the second valve 7, and to open the second valve 7 accurately at the predetermined valve-opening pressure. As a result, it is possible to decrease a malfunction of the second valve 7, and to improve a reliability of the second valve 7, which acts as the pressure-sensing valve that is opened by the spring force of the spring 10 when the pressure in the valve chamber 42 decreases to the predetermined valve-opening pressure.

In the construction of the comparative example shown in FIG. 7, the inner circumferential portion of the resin housing 5 does not slidably support the radially outermost portion 59 of the second valve 7. Thus, the coil spring 10 may be deflected on the skew depending on a seating state of the second valve 7, so that an off-center load acts on the second valve 7. Then, the second valve 7 is pushed on the skew just after the valve opening of the first valve 6, to vary a compression state of the molded rubber 9 forming the rubber seal portion 91, and to make the valve-opening time of the second valve 7 unstable. Further, when the second valve 7 is repeatedly seated on and lifted off the valve seat 8a of the resin housing 5, the second valve 7 may fall off the valve seat 8a of the resin housing 5 together with the molded rubber 9. As a result, it becomes unable to secure the airtightness between the valve seat 8a of the resin housing 5 and the molded rubber 9 of the second valve 7, to decrease durability and reliability of the valve.

In this regard, in the electromagnetic combination valve 1 according to the first embodiment of the present invention, the inner circumferential face of the cylindrical portion of the resin housing 5 at the side of the electromagnetic driving portion 2 with respect to the valve seat (the valve seat portion 8) is provided with a plurality of the valve guides 53 that slidably support the outer circumferential face of the radially outermost portion of the fitting portion 76 of the second valve 7. Thus, the second valve 7 is prevented from rattling in the radial direction, which is perpendicular to respect to the axial direction of the second valve 7. Accordingly, the rubber seal portion 91 of the molded rubber 9 is stabilized, and the second valve 7 can stably seat on the valve seat (on the valve seat portion 8) of the resin housing 5 without being slanted. Thus, the second valve 7 can stably repeat seating on and lifting off the valve seat (the valve seat portion 8) of the resin housing 5. As a result, it is possible to stabilize the valve-opening time and the valve-closing time of the second valve 7, and to prevent the second valve 7 from falling off the valve seat (the valve seat portion 8) of the resin housing 5 together with the molded rubber 9. Thus, it is possible to secure the airtightness of the gap between the valve seat (the valve seat portion 8) of the resin housing 5 and the rubber seal portion 91 of the molded rubber 9 on a semipermanent basis, and to improve the durability of the second valve, which acts as a pressure-sensing valve.

As described above, in the electromagnetic combination valve 1 according to the first embodiment of the present invention, the sealing lip portion 94, which is integrally formed on the surface of the rubber seal portion 91 of the molded rubber 9, has a shape that can realize elastic deformation seal in any direction (the shape having approximately right angled triangular cross-section with the surface inclined to the seal direction by around 45 degrees). Thus, the repulsive force of the molded rubber 9 (the repulsive force in the valve-opening direction) in the valve-closing time of the second valve 7 becomes smaller than the spring force of the coil spring 10 (than the urging force in the valve-opening direction). Further, the inner circumferential face of the cylindrical portion of the resin housing 5 at the side of the electromagnetic driving portion 2 with respect to the valve seat is provided with a plurality of the valve guides 53 that slidably supports the outer circumferential face of the radially outermost portion of the second valve 7. Thus, it is possible to improve the accuracy of the valve-opening property of the second valve 7. In the present embodiment, the molded rubber 9 can also absorb the traveling amount of the second valve 7 when the second valve 7 opens to release the compression force, within a range in which the molded rubber 9 can move in the elastically deformed sealing state.

Further, the molded rubber 9 is rubber molded (mold formed) on and in each annular end face of the second valve 7, so that the annular end face of the first valve 6 that faces the resin seal portion 61, is provided with the rubber seat portion 92 and the sealing lip portion 95, and the annular end face of the resin housing 5, which faces the valve seat (the valve seat portion 8), is provided with the rubber seal portion 91 and the sealing lip portion 94. Thus, the solenoid coil 3 of the electromagnetic driving portion 2 of the electromagnetic combination valve 1 stops being energized, and the solenoid coil 3 is demagnetized to erase the magnetomotive force thereof. Thus, the spring force of the return spring 30 absorbs the impactive force when the spring force seats the first and the second valves 6, 7 on the valve seat of the resin housing 5 (on the valve seat portion 8), to improve the durability and reliability of the electromagnetic combination valve 1.

### Modified Embodiment

In the first embodiment, the electromagnetic valve according to the present invention is adapted to the electromagnetic combination valve 1 that is incorporated in the ORVR system of a vehicle such as an automobile, especially to an electromagnetic tank-sealing valve. The electromagnetic valve according to the present invention is not limited to this kind of electromagnetic valve, and may be adapted to electromagnetic valves that are used in auxiliary machines and an air conditioning system mounted on a vehicle. The electromagnetic valve according to the present invention is applicable not only to gas such as air, vaporized fuel, etc., but also to air including gas phase refrigerant, to liquid including water, fuel and liquid phase refrigerant, and to two-phase fluid (combination of air phase fluid and liquid phase fluid). Further, in the first embodiment, the electromagnetic valve according to the present invention is adapted to a normally-closed electromagnetic opening/closing valve. The electromagnetic valve according to the present invention is also applicable to a normally-opened electromagnetic opening/closing valve. The electromagnetic valve according to the present invention may be configured so that the lift height of the first valve increases or decreases in accordance with an increase of voltage or current applied to the coil.

In the first embodiment, the valve seat of the resin housing 5 is provided with the valve seat portion 8 that is formed from metallic material. However, the valve seat of the resin housing 5 may have no valve seat portion 8. In a case that the valve seat of the resin housing 5 is not provided with the valve seat portion 8 as shown in FIG. 7, the whole of the valve seat of the resin housing 5 is formed from resinous material. Further, in the first embodiment, the second valve 7 has the lip valve construction and the resin housing 5 is provided with the valve guides 53. However, the electromagnetic valve according to the present invention may be configured so that the second valve 7 has a construction other than the lip valve construction and the resin housing 5 has no valve guide 53, or so that the second valve 7 has a construction other than the lip valve construction and the resin housing 5 is provided with the valve guides 53.

In the first embodiment, the sealing lip portion 94, which is formed on the surface of the rubber seal portion 91 of the molded rubber (the sealing rubber) 9, has the approximately right angled triangular cross-section and the one side of the sealing lip portion 94 is inclined to the seal direction (to the axial direction) by the predetermined angle (around 45 degrees, for example). Alternatively, the sealing lip portion 94 of the sealing rubber may have an approximately round cross-section or an approximately rectangular cross-section with a side inclined to the seal direction (to the axial direction) by a predetermined angle (around 45 degrees, for example). In the first embodiment, the sealing lip portion 95 has an approximately right angled triangular cross-section and the one side of the sealing lip portion 95 is inclined to the seal direction (to the axial direction) by a predetermined angle (around 45 degrees, for example). Alternatively, the sealing lip portion 95 of the sealing rubber may have an approximately round cross-section or an approximately rectangular cross-section with a side inclined to the seal direction (to the axial direction) by a predetermined angle (around 45 degrees, for example). The sealing lip portions 94, 95 may have hemispherical surfaces.

In the first embodiment, the molded rubber (the sealing rubber) 9 is formed from the rubber seal portion 91, the rubber seat portion 92, the rubber filled portion 93, and so on. Alternatively, the sealing rubber may be formed only from the rubber seal portion 91 that includes the sealing lip portion 94. In a case that the sealing rubber is formed only from the rubber seal portion 91, the first valve 6 may be configured so that the resin seal portion 61 of the first valve 6 is substituted by a rubber seal portion formed from rubber elastic body, and a sealing lip portion is formed on the surface of the rubber seal portion.

This description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electromagnetic combination valve comprising:
an electromagnetic driving portion having a coil that generates a magnetomotive force when it is energized;
a housing that has a valve seat formed in an approximately cylindrical shape in which a fluid passage hole is formed;
a spring that generates an urging force in an axial direction of the housing;
a first valve that is installed in the housing to be slidable in the axial direction, and opens by being attracted to one side in the axial direction by the magnetomotive force generated by the coil;
a second valve that is installed in the housing to be slidable in the axial direction, and opens by being urged to the one side in the axial direction by the urging force of the spring when a pressure of a fluid to urge the second valve in a valve-closing direction of the second valve decreases to a predetermined value when the first valve opens, the second valve having a sealing rubber on an end face thereof, which faces the valve seat of the housing to seat on the valve seat of the housing in a valve-closing time of the second valve, to form an airtight seal at a gap between the valve seat of the housing and the second valve, the sealing rubber being formed from rubber elastic body that generates a repulsive force smaller than the urging force of the spring in the axial direction in the valve-closing time of the second valve.

2. The electromagnetic combination valve according to claim 1, wherein:
the sealing rubber has a sealing lip portion that can be elastically deformed in any direction; and
the sealing lip portion can come in a direct contact with the valve seat of the housing in the valve-closing time of the second valve to form the airtight seal at the gap between the valve seat of the housing and the second valve.

3. The electromagnetic combination valve according to claim 2, wherein:
the sealing lip portion is formed to project from an end face of the second valve by a predetermined height toward the valve seat of the housing; and
a direction in which the sealing lip portion projects is inclined to the axial direction by a predetermined angle.

4. The electromagnetic combination valve comprising:
an electromagnetic driving portion having a coil that generates a magnetomotive force when energized;
a housing that has a valve seat with an approximately cylindrical shape in which a fluid passage hole is formed;
a spring that generates an urging force in an axial direction of the housing;
a first valve that is installed in the housing to be slidable in the axial direction, and opens by being attracted to one side in the axial direction by the magnetomotive force generated by the coil; and
a second valve that is installed in and supported by the housing to be slidable in the axial direction, and opens by being urged to the one side in the axial direction by the urging force of the spring when a pressure of a fluid to urge the second valve in a valve-closing direction of the second valve decreases to a predetermined value when the first valve opens, the second valve having a sealing rubber on an end face thereof, which faces the valve seat of the housing to seat on the valve seat of the housing in a valve-closing time of the second valve, to form an airtight seal the gap between the valve seat of the housing and the second valve, the sealing rubber being formed from rubber elastic body that generates a repulsive force in the valve-closing time of the second valve.

5. The electromagnetic combination valve according to claim 4, wherein:
the housing forms a cylindrical valve chamber between itself and the electromagnetic driving portion; and
the housing has a valve-sliding portion that supports the second valve to be slidable in the axial direction and protrudes from an inner circumferential face of the housing into the valve chamber by a predetermined protruding height.

6. The electromagnetic combination valve according to claim 1, wherein the sealing rubber is rubber printed or rubber molded at least on an end face of the second valve.
